(19) United States
(12) Patent Application Publication
(10) Pub. No.: US 2014/0002594 A1
(43) Pub. Date: Jan. 2, 2014

(54) HYBRID SKIP MODE FOR DEPTH MAP CODING AND DECODING

(71) Applicants: Yui-Lam Chan, Hong Kong (HK); Sik-Ho Tsang, Hong Kong (HK); Wan-Chi Siu, Hong Kong (HK); Hoi-Kok Cheung, Hong Kong (HK); Wai-Lam Hui, Hong Kong (HK); Pak-Kong Lun, Hong Kong (HK); Junyan Ren, Hong Kong (HK)

(72) Inventors: Yui-Lam Chan, Hong Kong (HK); Sik-Ho Tsang, Hong Kong (HK); Wan-Chi Siu, Hong Kong (HK); Hoi-Kok Cheung, Hong Kong (HK); Wai-Lam Hui, Hong Kong (HK); Pak-Kong Lun, Hong Kong (HK); Junyan Ren, Hong Kong (HK)

(73) Assignee: Hong Kong Applied Science and Technology Research Institute Company Limited, Hong Kong (HK)

(21) Appl. No.: 13/537,089

(22) Filed: Jun. 29, 2012

(51) Int. Cl. H04N 13/00

(52) U.S. Cl. 348/43; 348/E13.062

(57) ABSTRACT

A depth map image, unlike a texture view, has smooth regions without complex texture and abrupt changes of pixel value at the object edges. While conventional Inter-prediction skip mode is very efficient for coding texture views, it does not include any Intra-prediction capability, which can be very efficient for coding smooth regions. The hybrid prediction skip mode according to the presently claimed invention includes an Inter-prediction Skip mode coupled with various Intra-prediction modes. The selection of the prediction mode is made by computing a Side Match Distortion (SMD) for the prediction modes. Because no additional overhead indicator bit is required and that the bitstream syntax is not altered, high coding efficiency is maintained and the coding scheme for coding depth maps in accordance to the presently disclosed invention can be implemented easily as an extension to existing standards.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to video compression, encoding, and decoding. In particular, this invention relates to the prediction modes in the coding of depth data in multi-view videos.

### BACKGROUND

Typical video compression codecs, such as the H.264/AVC or HEVC, divide a picture or a frame in a video to be encoded into blocks of pixels, or macroblocks, of different sizes and assign prediction modes to these macroblocks. A macroblock size can be 16×16, 8×8, 4×4, 8×16, 16×8, 4×8, or 8×4. A prediction mode defines a method for generating a predicted data from previously encoded data, either spatial or temporal. The goal is to minimize the residual, or differences, between the predicted data and the original data. With the redundant data being discarded, the amount of data bits needed to be transmitted or stored for a video is therefore compacted, achieving data compression.

Prediction modes that are used to remove temporal redundancy are called Inter-prediction modes. Under the Inter-prediction modes, a current macroblock is re-created from both the residual data in the form of quantized transform coefficients and the motion vector information that points to a macroblock in a previously encoded/decoded frame—a reference frame. Therefore, instead of encoding the raw pixel values, which can be enormous in size, macroblocks in a frame can be represented and be coded by residual and motion vector data.

Skip mode is frequently applied on macroblocks and are referred to when a macroblock is coded without any residual or motion vector data. An encoder typically only encodes that a macroblock is skipped using overhead indicator bits. The decoder then interpolates the skipped macroblock by using the motion vectors of adjacent non-skipped macroblocks and/or the motion vector of a macroblock at the same location as the skipped macroblock in a frame later in the video playback time to predict a motion vector for the skipped macroblock (MVp).

Under the Inter-prediction modes, a typical encoder executes a motion estimation process to generate the motion vectors for the macroblocks in a current frame, in which it searches in a reference frame for matching macroblocks. This is particularly efficient for video sequences with no motion at all or motion that can exclusively be described by a translational model where inter frame correlation is high. On the other hand, the Inter-prediction modes are not effective for complex motions such as zooming or human motions. Inter-prediction modes can also be unreliable for video content that does not have a lot of texture.

A group of picture (GOP) structure of multiple frames is also associated with the Inter-prediction modes. A typical GOP structure is “IBBPBBP . . . ” in which an I-frame is followed by two B-frames, a P-frame, two B-frames, and then a P-frame. An I-frame is not Inter-predicted. It is encoded with raw pixel values, and serves as the reference frame. A P-frame is forward predicted from an earlier frame, mainly an I-frame. A B-frame refers to a bidirectional predicted frame that is predicted from an earlier and/or a later frame. In most video coding schemes, B-frames are not used as a reference to make further predictions in order to avoid a growing propagation prediction error. Further details on Inter-prediction modes in video coding are disclosed in the paper: Iain E Richardson, “White Paper: H.264/AVC Inter Prediction”, Vcodex, 2011; the disclosure of which is incorporated herein by reference its entirety.

The other prediction modes that are used to remove spatial redundancy are called Intra-prediction modes. An intra-predicted macroblock is predicted from its neighboring and previously-encoded macroblocks. In most video coding schemes, there are four optional Intra-prediction modes for 16×16 macroblocks: Vertical, Horizontal, DC, and Plane.

The Vertical mode means the extrapolation from samples from the upper neighboring macroblock. The Horizontal mode means the extrapolation from samples from the left neighboring macroblock. The DC mode means the mean of samples from the upper and the left neighboring macroblocks. The Plane mode means the results of a linear “plane” function being fitted to the samples from the upper and the left neighboring macroblocks. Normally the Intra-prediction mode with the least prediction error or residual data is selected for the Intra-prediction of a macroblock.

Other optional Intra-prediction modes are also used. For 4×4 macroblocks, there are a total of nine optional Intra-prediction modes. Further details on Intra-prediction modes in video coding are disclosed in the paper: Iain E Richardson, “White Paper: H.264/AVC Intra Prediction”, Vcodex, 2011; the disclosure of which is incorporated herein by reference its entirety.

Recent development in the art includes the coding of multi-view video. One example of such coding schemes is the MVC extension to the H.264/MPEG-4 AVC. A multi-view video, such as a three-dimensional video or a multi-view video plus depth, comprises of multiple views of each scene in the video sequence that were captured from different points of view or angles for view synthesis and other applications such as 3D movie playback. Depth data might also be included accompanying each view in the form of depth maps. FIG. 1 shows the depth maps 103 and 104 and their corresponding views 101 and 102 in a sample multi-view video sequence. These multi-view videos and new coding technologies enable advanced stereoscopic displays and auto-stereoscopic multiple view displays. However, in these multi-view videos, the amount of views and depths data or depth maps involved is generally enormous; therefore, there exists a desire of better data compression and coding efficiency than that of currently available solutions.

Compared to texture views, depth maps have different characteristics, which make color texture codec-based techniques less efficient for depth map coding. For one, a depth map does not have color texture as it contains only distance information between the capturing camera and the subject. Depth maps also have lower inter frame correlations than texture views. Therefore, conventional Inter-prediction and skip modes are rendered ineffective for depth maps.

U.S. Patent Application Publication No. 2011/0038418 discloses certain prediction modes for coding depth data that include additional depth difference information, wherein the depth difference information being the difference in depth values between a current macroblock and those of the left and the top macroblocks. This results in additional overheads, hence reducing the coding efficiency. U.S. Patent Application Publication No. 2011/0044550 also discloses a prediction mode for coding depth data, which incorporates the depth difference information related to a current, a left and a top macroblocks in conventional Inter-prediction skip mode. Similarly, this prediction mode results additional overheads and reduced coding efficiency.

### SUMMARY OF THE INVENTION

A depth map image, unlike a texture view, has smooth regions without complex texture and abrupt changes of pixel value at the object edges. While conventional Inter-prediction skip mode is very efficient for coding texture views, it does not include any Intra-prediction capability, which can be very efficient for coding smooth regions.

It is an objective of the presently claimed invention to provide a more effective coding scheme for coding depth maps in a multi-view video, particularly a prediction technique that combines the features of both Inter-prediction and Intra-prediction without additional overhead bits in the encoded video. It is a further objective of the presently claimed invention to provide such coding scheme that allows the bitstream syntax to remain unchanged from current standards.

In accordance to various embodiments of the presently claimed invention, a method of macroblock prediction being performed by a video encoder on a depth map in an un-encoded multi-view video sequence comprises: receiving a frame of the depth map; and performing Inter-prediction on a first macroblock within the frame, wherein the Inter-prediction comprising: determining the first macroblock within the frame to be skipped; removing all pixel data in the first macroblock from being encoded in an encoded bitstream for the frame of the depth map; and including one or more indicator bits indicating the first macroblock being encoded as skipped macroblock for composing the frame of the depth map in the encoded bitstream output by the encoder.

In accordance to various embodiments of the presently claimed invention, a method of macroblock prediction being performed by a video decoder on a depth map in an encoded multi-view video sequence comprises: receiving a frame of the depth map; performing Inter-prediction on a first skipped macroblock within the frame to obtain a current Inter-predicted macroblock of the first skipped macroblock, wherein the Inter-prediction comprising: locating the first skipped macroblock within the frame by identifying one or more indicator bits; determining a predicted motion vector by using motion vectors of one or more macroblocks neighboring the first skipped macroblock; and predicting the first skipped macroblock by interpolating from the predicted motion vector and a second macroblock in a reference frame in the depth map in the encoded multi-view video sequence; performing a Vertical mode Intra-prediction on the first skipped macroblock to obtain a current Vertical mode Intra-predicted macroblock of the first skipped macroblock; performing a Horizontal mode Intra-prediction macroblock of the on the first skipped macroblock to obtain a current Horizontal mode Intra-predicted macroblock of the first skipped macroblock; performing a DC mode Intra-prediction on the first skipped macroblock to obtain a current DC mode Intra-predicted macroblock of the first skipped macroblock; and performing a Plane mode Intra-prediction on the first skipped macroblock to obtain a current Plane mode Intra-predicted macroblock of the first skipped macroblock.

The decoder further selects the best of the five predicted macroblocks of the first skipped macroblock resulted from the Inter-prediction, Vertical mode Intra-prediction, Horizontal mode Intra-prediction, DC mode Intra-prediction, and Plane mode Intra-prediction by computing a Side Match Distortion (SMD) for each of the predicted macroblocks. The one predicted macroblock with the smallest SMD is selected for the composing the frame of the depth map in the decoded bitstream output by the decoder.

Because no residual data is coded for the skipped macroblocks, no additional overhead indicator bit is required for the selection of the predicted macroblocks resulted from the different prediction modes, that all computation of the selection use only data available in the encoder and decoder, and that the bitstream syntax of the encoded multi-view video is not altered, high coding efficiency is maintained and the coding scheme for coding depth maps in accordance to the presently disclosed invention can be implemented easily as an extension to existing standards such as H.264/AVC or HEVC.

### BRIEF DESCRIPTION OF THE DRAWINGS

Embodiments of the invention are described in more detail hereinafter with reference to the drawings, in which

FIG. 1 depicts a depth map and its corresponding views in a sample multi-view video sequence; and

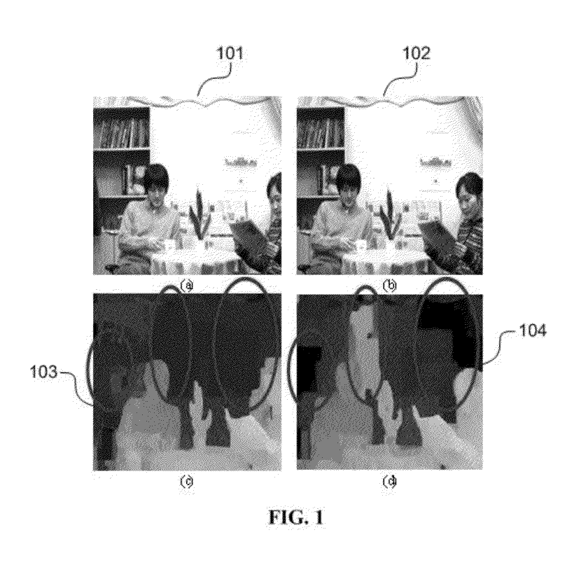

FIG. 2 depicts a conceptual illustration of macroblock prediction modes in accordance to various embodiments of the presently claimed invention.

### DETAILED DESCRIPTION OF THE PREFERRED EMBODIMENTS

In the following description, systems and methods for multi-view video depth map coding and decoding with a hybrid prediction skip mode and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to various embodiments of the presently claimed invention, a process of macroblock prediction in multi-view video depth map coding can be applied in a video compression, transmission, and playback system comprising: a source of un-encoded multi-view video with depth map data; an encoder for performing compression and encoding of the un-encoded multi-view video with depth map including the execution of the method of macroblock prediction on the depth map; an transmitter for transmitting bitstreams of an encoded multi-view video with depth map in a communication carrier signal; a signal transmission medium for transporting the communication carrier signal; a receiver for receiving the communication carrier signal and extracting the bitstreams of the encoded multi-view video with depth map; a decoder for decoding the encoded multi-view video with depth map including the execution of the method of macroblock prediction on the depth map; and a video playback device for displaying the decoded multi-view video with depth map.

In accordance to various embodiments of the presently claimed invention, a process of prediction being performed by a video encoder on a depth map in an un-encoded multi-view video sequence comprises: receiving a frame of the depth map; and performing Inter-prediction on a first macroblock within the frame, wherein the Inter-prediction comprising: determining the first macroblock within the frame to be skipped; removing all pixel data in the first macroblock from being encoded in an encoded bitstream for the frame of the depth map; and including one or more indicator bits indicating the first macroblock being encoded as skipped macroblock for composing the frame of the depth map in the encoded bitstream output by the encoder. No motion vector or residual data, for Inter-prediction or Intra-prediction, is encoded for the skipped macroblock.

In accordance to various embodiments of the presently claimed invention, a method of prediction being performed by a video decoder on a depth map in an encoded multi-view video sequence comprises: receiving a frame of the depth map; performing Inter-prediction on a first skipped macroblock within the frame to obtain a current Inter-predicted macroblock of the first skipped macroblock, wherein the Inter-prediction comprising: locating the first skipped macroblock within the frame by identifying one or more indicator bits; determining a predicted motion vector by using motion vectors of one or more macroblocks neighboring the first skipped macroblock; and predicting the first skipped macroblock by interpolating from the predicted motion vector and a second macroblock in a reference frame in the depth map in the encoded multi-view video sequence; performing a Vertical mode Intra-prediction on the first skipped macroblock to obtain a current Vertical mode Intra-predicted macroblock of the first skipped macroblock; performing a Horizontal mode Intra-prediction macroblock of the on the first skipped macroblock to obtain a current Horizontal mode Intra-predicted macroblock of the first skipped macroblock; performing a DC mode Intra-prediction on the first skipped macroblock to obtain a current DC mode Intra-predicted macroblock of the first skipped macroblock; and performing a Plane mode Intra-prediction on the first skipped macroblock to obtain a current Plane mode Intra-predicted macroblock of the first skipped macroblock.

The hybrid prediction skip mode according to the presently claimed invention, thus, includes a Inter-prediction Skip mode, Intra-prediction Vertical mode, Intra-prediction Horizontal mode, Intra-prediction DC mode, and Intra-prediction Plane mode, which can be denoted by:

Hybrid Skip Mode={Inter_Skip, I16_Ver_Skip, I16_Hor_Skip, I16_DC_Skip, I16_Plane_Skip}
where macroblock size=16×16

Inter_Skip:

p_{pred}(x, y)−p_{ref}(x+MVpₓ, y+MVp_{y}); x, y={0, 1, . . . , 15}
where:
   p_{pred} is a pixel in the current predicted macroblock;
   p_{ref} is a pixel in a macroblock in the reference frame; and
   MVp is a predicted motion vector

I16_Ver_Skip:

p_{pred}(x, y)=pᵤₚ(x); x, y={0, 1, . . . , 15}
where pᵤₚ is a pixel in the macroblock edge located immediately bordering the top of the current predicted macroblock

I16_Hor_Skip:

p_{pred}(x, y)=p_{left}(x); x, y={0, 1, . . . , 15}
where p_{left} is a pixel in the macroblock edge located immediately bordering the left side of the current predicted macroblock

I16_DC_Skip:

p_{pred}(x, y)=(Σ_{x=0, 1, . . . , 15} pᵤₚ(x)+Σ_{y=0, 1, . . . , 15} p_{left}(y))>>5;
x, y={0, 1, . . . , 15}

I16_Plane_Skip:

p_{pred}(x,y)=(a+b×(−7)+c×(y−7)+16)>>5;
x, y={0, 1, . . . , 15}
where:

a=16×(p_{left}(15)+pᵤₚ(15));

b=(5×H+32)>>6;

c=(5×V+32)>>6;

H=Σ_{x=0, 1, . . . , 7}[(x+1)×(p_{left}(8+x)×(p_{left}(6−x))];

V=Σ_{y=0, 1, . . . , 7}[(y+1)×(pᵤₚ(8+x)−pᵤₚ(6−x))];

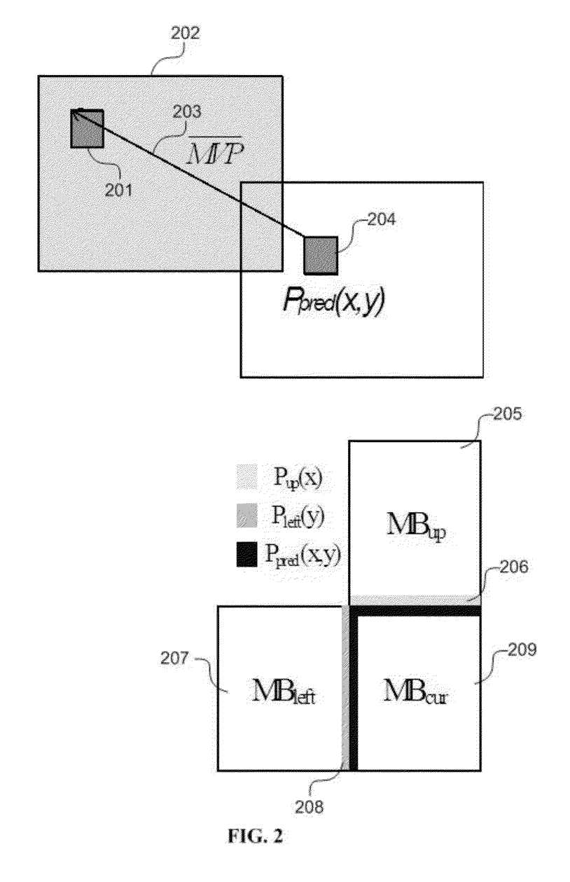

Referring to FIG. 2. FIG. 2 conceptually shows p_{ref} in the macroblock 201 in the reference frame 202, the predicted motion vector MVp 203, and p_{pred} in the current predicted macroblock 204 in the Inter-prediction step. Also shown in FIG. 2 are p_{pred}, pᵤₚ, and p_{left} in the current predicted macroblock 209, macroblock edge 206 located immediately bordering the top of the current predicted macroblock 205, and the macroblock edge 208 located immediately bordering the left side of the current predicted macroblock 207 respective.

The decoder further selects one of the five current predicted macroblocks of the first skipped macroblock resulted from the Inter-prediction, Vertical mode Intra-prediction, Horizontal mode Intra-prediction, DC mode Intra-prediction, and Plane mode Intra-prediction with the best prediction based on a certain criteria that does not rely on any additional overhead bits in the encoded multi-view video sequence bitstream or any information external to that already received by the decoder. In a preferred embodiment, a Side Match Distortion (SMD) for each of the current predicted macroblocks is used as the selection criteria. The one current predicted macroblock with the smallest SMD is selected for the composing the frame of the depth map in the decoded bitstream output by the decoder.

In accordance to one embodiment, a SMD for a predicted macroblock and the selection of the best prediction type is computed by the following equation:

SMD_{type}=Σ_{x=0, 1, . . . , 15} |p_{pred}(x, 0)−pᵤₚ(x)|+Σ_{y=0, 1, . . . , 15}|p_{pred}(0, y)−p_{left}(y)|;
type_{best}=arg_{type}min(SMD_{type})
where:
   p_{pred} is a pixel in the current predicted macroblock;
   pᵤₚ s a pixel in the macroblock edge located immediately bordering the top of the current predicted macroblock;
   p_{left} is a pixel in the macroblock edge located immediately bordering the left of the current predicted macroblock

In preferred embodiments, the size of the macroblock is 16×16. However, macroblocks of other sizes such as 8×8, 4×4, 16×8, and 8×16 are also supported with a substantially similar process as that described above.

Typically, an electrical signal encoded with data is subjected to the process described above; the output will be a compressed signal. A compressed signal is then input to the inverse process to substantially reproduce the original data-encoded electrical signal.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method of macroblock prediction in video coding of depth data in a multi-view video, comprising:
encoding, by a video encoder, a depth map in an un-encoded multi-view video sequence comprising:
receiving a frame of the depth map in the un-encoded multi-view video sequence;
performing a Inter-prediction skip mode on a first macroblock within the frame to generate one or more indicator bits associating with the first macroblock being skipped; and
composing and outputting an encoded multi-view video sequence with depth map, which includes the one or more indicator bits;
decoding, by a video decoder, the depth map in the encoded multi-view video sequence comprising:
receiving a frame of the depth map in the encoded multi-view video sequence;
performing Inter-prediction on a first skipped macroblock within the frame to obtain a current Inter-predicted macroblock of the first skipped macroblock, wherein the Inter-prediction comprising:
locating the first skipped macroblock within the frame by identifying one or more indicator bits;
determining a predicted motion vector by using motion vectors of one or more macroblocks neighboring the first skipped macroblock; and
predicting the first skipped macroblock by interpolating from the predicted motion vector and a second macroblock in a reference frame in the depth map in the encoded multi-view video sequence;
performing one or more Intra-prediction of different modes on the first skipped macroblock to obtain one or more current Intra-predicted macroblock of different modes respectively;
selecting one current predicted macroblock from the current Inter-predicted macroblock and the one or more Intra-predicted macroblocks based on a selection criteria; and
composing and outputting a decoded multi-view video sequence with depth map, which includes the selected current predicted macroblock.

2. The method of claim 1, wherein sizes of the first macroblock, the first skipped macroblock, the current Inter-predicted macroblock, and the one or more current Intra-predicted macroblocks are 16×16.

3. The method of claim 1, wherein the performance of one or more Intra-prediction of different modes on the first skipped macroblock comprising:
performing a Vertical mode Intra-prediction on the first skipped macroblock to obtain a current Vertical mode Intra-predicted macroblock of the first skipped macroblock;
performing a Horizontal mode Intra-prediction macroblock of the on the first skipped macroblock to obtain a current Horizontal mode Intra-predicted macroblock of the first skipped macroblock;
performing a DC mode Intra-prediction on the first skipped macroblock to obtain a current DC mode Intra-predicted macroblock of the first skipped macroblock; and
performing a Plane mode Intra-prediction on the first skipped macroblock to obtain a current Plane mode Intra-predicted macroblock of the first skipped macroblock.

4. The method of claim 1, wherein the selection criteria being the current predicted macroblock having a smallest Side Match Distortion (SMD) is selected; wherein a SMD of a current predicted macroblock is computed by:
SMD=Σ_{x=0, 1, . . . , 15}|p_{pred}(x, 0)−pᵤₚ(x)|+Σ_{y=0, 1, . . . , 15}|p_{pred}(0, y)−p_{left}(y)|;
and wherein:
p_{pred} is a pixel in the current predicted macroblock;
pᵤₚ is a pixel in a macroblock edge located immediately bordering top of the current predicted macroblock; and
p_{left} is a pixel in a macroblock edge located immediately bordering left of the current predicted macroblock.

5. The method of claim 1, wherein sizes of the first macroblock, the first skipped macroblock, the current Inter-predicted macroblock, and the one or more current Intra-predicted macroblocks are 8×8.

6. The method of claim 1, wherein sizes of the first macroblock, the first skipped macroblock, the current Inter-predicted macroblock, and the one or more current Intra-predicted macroblocks are 4×4.

7. The method of claim 1, wherein sizes of the first macroblock, the first skipped macroblock, the current Inter-predicted macroblock, and the one or more current Intra-predicted macroblocks are 16×8.

8. The method of claim 1, wherein sizes of the first macroblock, the first skipped macroblock, the current Inter-predicted macroblock, and the one or more current Intra-predicted macroblocks are 8×16.

9. A system for video coding of depth data in a multi-view video, comprising:
a video encoder for performing an encoding of a depth map in an un-encoded multi-view video sequence, the encoding comprising:
receiving a frame of the depth map in the un-encoded multi-view video sequence;
performing a Inter-prediction skip mode on a first macroblock within the frame to generate one or more indicator bits associating with the first macroblock being skipped; and
composing and outputting an encoded multi-view video sequence with depth map, which includes the one or more indicator bits;
a video decoder for performing a decoding of the depth map in the encoded multi-view video sequence, the decoding comprising:
receiving a frame of the depth map in the encoded multi-view video sequence;
performing Inter-prediction on a first skipped macroblock within the frame to obtain a current Inter-predicted macroblock of the first skipped macroblock, wherein the Inter-prediction comprising:
locating the first skipped macroblock within the frame by identifying one or more indicator bits;
determining a predicted motion vector by using motion vectors of one or more macroblocks neighboring the first skipped macroblock; and
predicting the first skipped macroblock by interpolating from the predicted motion vector and a second macroblock in a reference frame in the depth map in the encoded multi-view video sequence;
performing one or more Intra-prediction of different modes on the first skipped macroblock to obtain one or more current Intra-predicted macroblock of different modes respectively;
selecting one current predicted macroblock from the current Inter-predicted macroblock and the one or more Intra-predicted macroblocks based on a selection criteria; and
composing and outputting a decoded multi-view video sequence with depth map, which includes the selected current predicted macroblock.

10. The system of claim 9, wherein sizes of the first macroblock, the first skipped macroblock, the current Inter-predicted macroblock, and the one or more current Intra-predicted macroblocks are 16×16.

11. The method of claim 9, wherein the performance of one or more Intra-prediction of different modes on the first skipped macroblock comprising:
performing a Vertical mode Intra-prediction on the first skipped macroblock to obtain a current Vertical mode Intra-predicted macroblock of the first skipped macroblock;
performing a Horizontal mode Intra-prediction macroblock of the on the first skipped macroblock to obtain a current Horizontal mode Intra-predicted macroblock of the first skipped macroblock;
performing a DC mode Intra-prediction on the first skipped macroblock to obtain a current DC mode Intra-predicted macroblock of the first skipped macroblock; and
performing a Plane mode Intra-prediction on the first skipped macroblock to obtain a current Plane mode Intra-predicted macroblock of the first skipped macroblock.

12. The method of claim 9, wherein the selection criteria being the current predicted macroblock having a smallest Side Match Distortion (SMD) is selected; wherein a SMD of a current predicted macroblock is computed by:
SMD=Σ_{x=0, 1, . . . , 15}|p_{pred}(x, 0)−pᵤₚ(x)|+Σ_{y=0, 1, . . . , 15}|p_{pred}(0, y)−p_{left}(y)|;
and wherein:
p_{pred} is a pixel in the current predicted macroblock;
pᵤₚ is a pixel in a macroblock edge located immediately bordering top of the current predicted macroblock; and
p_{left} is a pixel in a macroblock edge located immediately bordering left of the current predicted macroblock.

13. The method of claim 9, wherein sizes of the first macroblock, the first skipped macroblock, the current Inter-predicted macroblock, and the one or more current Intra-predicted macroblocks are 8×8.

14. The method of claim 9, wherein sizes of the first macroblock, the first skipped macroblock, the current Inter-predicted macroblock, and the one or more current Intra-predicted macroblocks are 4×4.

15. The method of claim 9, wherein sizes of the first macroblock, the first skipped macroblock, the current Inter-predicted macroblock, and the one or more current Intra-predicted macroblocks are 16×8.

16. The method of claim 9, wherein sizes of the first macroblock, the first skipped macroblock, the current Inter-predicted macroblock, and the one or more current Intra-predicted macroblocks are 8×16.
